(19) United States
(12) Patent Application Publication
(10) Pub. No.: US 2009/0307750 A1
(43) Pub. Date: Dec. 10, 2009

(54) Internet-based access controlled consumption of content and services using client-side credentials

(76) Inventors: Sunny Marueli, Ramat Hasharon (IL); Tovi Riegler, Mazkeret Batia (IL)

Correspondence Address: Ronny Fogel;c/o Daltan Consulting Ltd., P.O.Box 1146, Kfar Sava, 44110, IL

(21) Appl. No.: 12/453,842

(22) Filed: May 26, 2009

Related U.S. Application Data
(60) Provisional application No. 61/131,260, filed on Jun. 9, 2008.

(51) Int. Cl. G06F 21/00; G06F 17/30; G06F 3/048

(52) U.S. Cl. 726/3; 707/3; 715/760; 707/E17.014; 707/E17.032; 707/E17.108

(57) ABSTRACT

System and methods for controlling access to internet content, comprising: a web-server; a client computer comprising a web-browser, communicating with the web-server over the internet; means for adding at least one characteristic of the client computer user to a web-page request sent from the client computer to the web-server; means for identifying the at least one characteristic of the client computer user; and means for selectively responding to the web page request, based on said at least one characteristic.

### CROSS-REFERENCE TO RELATED PATENT APPLICATIONS

This patent application claims priority from and is related to U.S. Provisional Patent Application Ser. No. 61/131,260, filed 9 Jun. 2008, this U.S. Provisional Patent Application incorporated by reference in its entirety herein.

### TECHNOLOGY FIELD

The invention relates to system and methods of accessing the Internet. In particular it relates to using user identifiers to control delivered content.

### BACKGROUND

Some segments of the population do not want (or should not) be exposed to some content available on the Internet. Such groups include minors, religious groups, etc. For example, there is abundance of content and services not suitable for children on the Internet, such as pornographic and violent content. Similarly, a religious community may wish not to be exposed to some content or services as they may not be compatible with their beliefs.

Today, ‘access-control’ applications (either installed directly or supplied as a service—e.g. by the ISP) can be used (mostly by parents on behalf of their children) to limit access to only “white-listed” web-sites or limit access to “black-listed” addresses. However, this solution requires a constant update of the lists by volunteers and/or paid-personnel.

The requirements from adult content (or any content/service not suitable for minors) owners are minimal—users are required to certify they are of a certain age (e.g. 18 for adult content; 13 for other types of content/services) before accessing the restricted content/service. For example, service operators and content providers can claim ignorance of who their user/client is and whether or not they are entitled to agree to their end-user license agreement.

U.S. Pat. No. 6,041,355 to Intel Corp. discloses a method of controlling the transfer of data between a first and a second computer network comprises parsing content description language received from the first computer network by the second computer network to determine current tag information within the content description language. A completion decision is then dynamically made based upon the current tag information. The method uses a filtering router and a web proxy to filter requests.

Published Patent Application No. WO2003043287 to Serendipity Interactive Ltd. et al discloses a system and method for accessing the Internet. In particular, it relates to using unique identity markers to label requests, such that for each request certain rules are retrieved from a database depending on the user or workstation in question, and this controls access to certain Internet sites. The method uses a proxy server having a rules database for granting content permissions.

Published Patent Application No. WO2007066183 to Nokia Corp. discloses a system and method for establishing a data communications session, involving determining a personal characteristic associated with a user of a terminal. A predetermined criterion for allowing establishment of the data communications session based on the personal characteristic is obtained. A token is embedded in a signaling message used to establish the data communications session. The token represents at least one of the personal characteristic and the predetermined criterion. The signaling message is communicated with a network entity capable of allowing users to establish the data communications session. The data communications session is established via the network entity if the personal characteristic satisfies the predetermined criterion. The method refers to instant messaging applications and uses a network service to provide an allowed sessions' list to the requester or to allow/prohibit access to a predefined session.

### SUMMARY

System and methods for controlling access to internet content, comprising: a web-server; a client computer comprising a web-browser, communicating with the web-server over the internet; means for adding at least one characteristic of the client computer user to a web-page request sent from the client computer to the web-server; means for identifying the at least one characteristic of the client computer user; and means for selectively responding to the web page request, based on said at least one characteristic.

### BRIEF DESCRIPTION OF THE DRAWINGS

FIG. 1 is a schematic drawing of the system components for carrying out the method of the invention;

FIG. 2 is a flowchart describing the various steps taken for providing an ID with each web-page request; and

FIG. 3 is a flowchart describing the various steps taken by the ID handling software module.

### DETAILED DESCRIPTION OF PREFERRED EMBODIMENTS

The present invention provides a system and method for Internet-based access; controlled consumption of content and services using client-side credentials.

The method allows users (or proxies, such as schools, parents, church, etc.) to voluntarily provide content and service providers with information regarding their legal status and/or preferences regarding the content/service they wish (or are entitled) to be exposed to. For example, this would allow a news site to filter out stories or ads not suitable for children.

The method exposes and allows a content and service provider to indentify a user as (for example) a minor and prohibit, filter or modify the content/service provided to that user, without requiring any further involvement from the user. Where legal restrictions apply (e.g. minors), providers will have to modify their content/service according to the self provided information by the user.

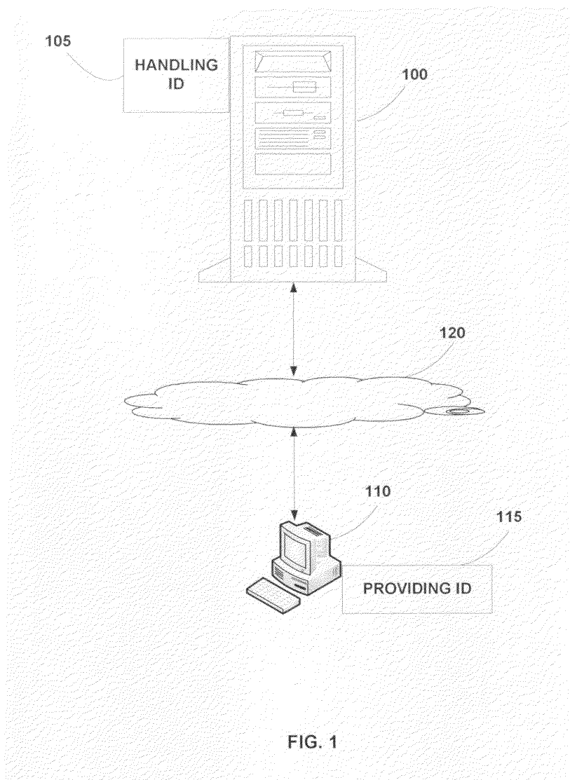

FIG. 1 is a schematic drawing of the system components for carrying out the method of the invention.

The system comprises a web-server (100), optionally including software means (105) for identifying user ID and handling requests accordingly, and a user computer (110), including software means (115) for providing an ID with each web-page request. The web server (100) and the user computer (110) communicate over the Internet (120).

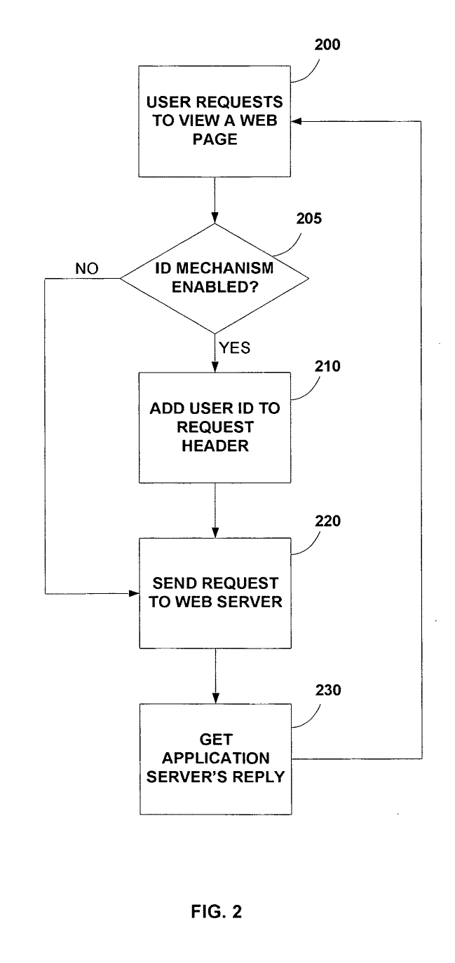

FIG. 2 is a flowchart describing the various steps taken by the software module (115), for providing an ID with each web-page request. Software module (115) may be implemented either as an add-on to the user's web-browser (e.g. Internet Explorer BHO—Browser Helper Object), or as a component installed on the user's computer.

In step (200), the user requests to view a certain web page. The request may be performed by entering a URL address in the browser, or by pressing a link in a currently viewed page, etc.

In step (205) the software module (115) checks whether the ID mechanism is enabled or disabled by authorized persons (e.g. parents). Password protection or some other access control method (e.g. fingerprint) may prevent an unauthorized person (e.g. child) from disabling the ID mechanism.

If the ID mechanism is disabled, the user's original request is sent to the web server.

If the ID mechanism is enabled, the user ID is added to the request header (step 210).

According to an embodiment of the invention, the method consists of adding a new optional ‘header’ to the HTTP protocol that will indicate “properties” of the user, which web-site programmers can then choose to adhere to. The header can be identified and generate a changed behavior by the web server. Alternatively, an existing header, such as ‘User-Agent’ may be modified to include the additional information.

As an example, the following is a typical HTTP request:

GET/HTTP/1.1

Host: www.playboy.com

Connection: close

User-Agent: Mozilla/4.0 (compatible; MSIE 7.0; Windows NT 5.1)

Accept-Encoding: gzip

Accept-Charset: ISO-8859-1,UTF-8;q=0.7,*;q=0.7

Cache-Control: no

Accept-Language: de,en;q=0.7,en-us;q=0.3

The system may add a new header (the name and format of the new header may be different) such as:

GET/HTTP/1.1

Host: www.playboy.com

Connection: close

User-Agent: Mozilla/4.0 (compatible; MSIE 7.0; Windows NT 5.1)

Accept-Encoding: gzip

Accept-Charset: ISO-8859-1,UTF-8;q=0.7,*;q=0.7

Cache-Control: no

User-Info: age=childunder13

Accept-Language: de,en;q=0.7,en-us;q=0.3

In the alternative embodiment, where the information is embedded in the User-Agent header:

GET/HTTP/1.1

Host: www.playboy.com

Connection: close

User-Agent: Mozilla/4.0 (compatible; MSIE 7.0; Windows NT 5.1; User-Info:

age=childunder13)

Accept-Encoding: gzip

Accept-Charset: ISO-8859-1,UTF-8;q=0.7,*;q=0.7

Cache-Control: no

Accept-Language: de,en;q=0.7,en-us;q=0.3

This indicates that only content suitable for a child should be presented to the user. Additional indications may be optionally provided by the user (or rather his/her custodian). For example, the MPAA rating system could be used in addition to the user's age, and the custodian may indicate that even though the user is 13 years old, the content provided must meet the “PG” (Parental Guidance) guidelines. Using current web-server software (e.g. Apache, Microsoft IIS) web-site programmers can easily recognize the proposed header, and present suitable child content, in a similar manner to that by which the “Accept-Language” header identifies preferred languages for the content (in this example—German and English).

In step (220), software module (115) sends the modified user's request to the web server and in step (230) the user computer receives a response. The response may be in the form of displaying the requested web-page in his browser, or, if completely or partially prohibited by his ID, the response may comprise a notification to that effect, and/or partial display of the requested page, in which unsuitable content has been removed or masked out. The modified page sent in response to the user's request depends on the user-info; e.g. the content provider may have created two different pages and replied with the correct one (after examining the header); alternatively, the modified web-page may be generated “on the fly”.

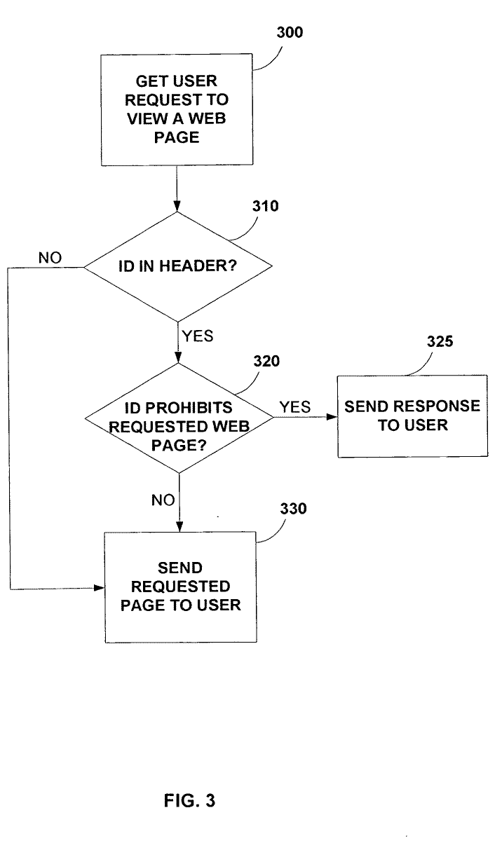

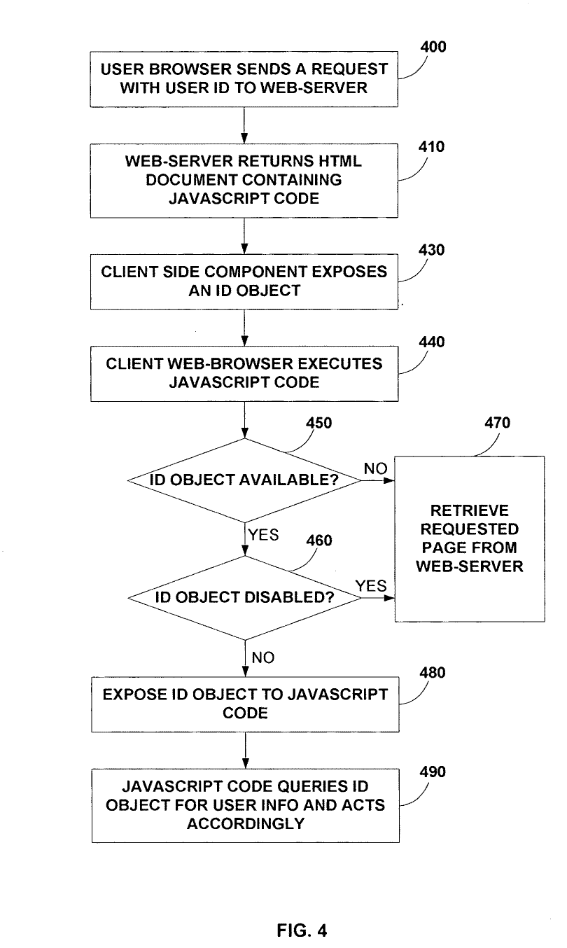

FIG. 3 is a flowchart describing the various steps taken by the web-server's ID handling software module (105).

In step (300), the web server (100) receives the user's request to view a web page.

In step (310), module (105) checks whether a user ID has been incorporated in the header.

If no ID is found, the web server proceeds to fulfill the user's request.

If an ID is found in the header, module (105) checks (step 320) whether the requested web-page fits the criteria in the ID.

If affirmative—the web server proceeds to fulfill the user's request.

Otherwise, if the requested web-page is fully or partially prohibited from being displayed to the user, according to his ID, module (105) may optionally send a response to that effect to the user (step 325). The response may comprise redirection to a different page, removal of unsuitable content from the requested page, or a message stating that the requested page is prohibited. The modified page sent in response to the user's request depends on the user-info; e.g. the content provider may have created two different pages and replied with the correct one (after examining the header); alternatively, the modified web-page may be generated “on the fly”.

For example, the following may be the header for a reply from a web-site for a content which was modified to filter out unsuitable content:

HTTP Status Code: HTTP/1.1 200 OK

Date: Thu, 22 May 2008 14:05:08 GMT

Server: Apache

User-Info: age=12

Transfer-Encoding: chunked

Content-Type: text/html

Connection: close

An alternative method is to inject special ‘cookies’ to indicate the user information. For example:

HTTP Status Code: HTTP/1.1 200 OK

Date: Thu, 22 May 2008 14:05:08 GMT

Server: Apache

Cookie: User-Info=age:12

Transfer-Encoding: chunked

Content-Type: text/html

Connection: close

Note that the HTTP protocol specifies that web-server software can safely ignore any HTTP header it does not recognize. Therefore, unless a web-site is configured to recognize this header, there should be no adverse effect on receiving parties. However, in some cases, depending on web server policies, a log file may be created that can be served as log or proof of such a user accessing said content/service.

Content/service providers may optionally report whether they have processed the proposed user notification, and whether the content/service returned to the user was modified.

According to another embodiment of the invention, the web-server's ID handling component (105) may be replaced by a modified HTML and client-side code, such as e.g. JavaScript or Adobe Flash. This code is sent by the web-server but executed by the web-browser. In this embodiment, the client-side code is responsible for identifying the user ID and acting accordingly.

To facilitate the client-side code to identify the existence of an ID, two exemplary methods are proposed:

(1) The client-side code can identify standard information exposed by the web-browser (e.g. the ‘user-agent’ published by the browser); or

(2) A client-side component (e.g. plug-in or Internet Explorer BHO) may expose some information that is accessible by the client-side code. For example, the client-component may expose an object which identifies its existence, and can be queried for the user information which can then be used when rendering the page (potentially issuing additional requests to the server).

FIG. 4 is a flowchart describing the various steps taken by the client-side component according to an example of this embodiment.

In step (400), the user browser sends a web-page request to the web-browser. The web-server (step 410) returns an HTML document containing JavaScript code, either embedded or as a separate file.

In step (430), the client-side component (plug-in) exposes a special object that will then S be accessible by the client-side code (e.g. JavaScript) which was sent with the document. This step only takes place if the user ID providing module (115) has not been disabled, i.e. an ID header has been sent with the page request and the object expose function has not been disabled.

In step (440), the client web-browser executes the JavaScript code and attempts to access the object provided by the client-side plug-in (step 450). If an object is available, it is checked (step (460) to see whether it is enabled, and if affirmative, it is exposed by the client side component (plug-in) to the client-side code (e.g. JavaScript) (step 480). The JavaScript may now query the object for user information (step 490) and act accordingly. For example, it may retrieve an objectionable image from the web-browser only if it did not find an indication that the user is minor. Otherwise, it may instead render text stating the content is not appropriate.

If in step (450) the object was not found, namely the client-side component (plug-in) is not available, or is in a ‘disabled’ mode, or if in step (460) the object was found to be disabled, the web-browser proceeds to retrieve the requested web page from the web-browser (step 470).

1. A system for controlling access to internet content, comprising:
a web-server;
a client computer comprising a web-browser, communicating with the web-server over the internet;
means for adding at least one characteristic of the client computer user to a web-page request sent from the client computer to the web-server;
means for identifying the at least one characteristic of the client computer user; and
means for selectively responding to the web page request, based on said at least one characteristic.

2. The system of claim 1, wherein said means for adding at least one characteristic comprise an add-on to the client computer's web-browser.

3. The system of claim 1, wherein said means for adding at least one characteristic comprise a software component installed on the client computer.

4. The system of claim 1, wherein said means for adding at least one characteristic comprise means for modifying a header of said request.

5. The system of claim 4, wherein said means for modifying the header comprise means for modifying the user-agent header.

6. The system of claim 1, wherein said means for adding at least one characteristic comprise means for adding a new header to said request.

7. The system of claim 1, wherein the means for identifying the at least one characteristic comprise software means residing on the web server.

8. The system of claim 7, wherein the means for selectively responding to the web-page request comprise:
means for checking the requested web page for compatibility with said at least one user characteristic;
means for sending the requested web-page to the user if the web-page is compatible with the at least one user characteristic;
means for masking out incompatible parts of the requested web-page if the web-page is partially compatible with the at least one user characteristic; and
means for notifying the user that the requested page is incompatible with the at least one user characteristic.

9. The system of claim 8, additionally comprising means for redirecting the user to an alternative web-page if the requested page is incompatible with the at least one user characteristic.

10. The system of claim 1 wherein the means for identifying the at least one characteristic comprise web-server means for sending an HTML document containing client-side code to the client computer.

11. The system of claim 10, wherein said client-side code is embedded in said HTML document.

12. The system of claim 10, wherein said client-side code comprises a separate document.

13. The system of claim 10, wherein said client-side code comprises a JavaScript.

14. The system of claim 10, wherein the means for selectively responding to the web-page request comprise:
web-browser means for executing said client-side code;
means for exposing an ID object to said client-side code if said ID object is available and enabled; and
means for querying said ID object for said at least one user characteristic.

15. The system of claim 14, wherein the means for selectively responding to the web-page request comprise:
means for checking the requested web page for compatibility with said at least one user characteristic;
means for sending the requested web-page to the user if the web-page is compatible with the at least one user characteristic;
means for masking out incompatible parts of the requested web-page if the web-page is partially compatible with the at least one user characteristic; and
means for notifying the user that the requested page is incompatible with the at least one user characteristic.

16. The system of claim 15, additionally comprising means for redirecting the user to an alternative web-page if the requested page is incompatible with the at least one user characteristic.

17. A method of controlling access to internet content, comprising:
adding at least one characteristic of a client computer user to a web-page request sent from the client computer to a web-server;
identifying the at least one characteristic of the client computer user; and
selectively responding to the web page request, based on said at least one characteristic.

18. The method of claim 17, wherein said adding at least one characteristic is performed by an add-on to the client computer's web-browser.

19. The method of claim 17, wherein said adding at least one characteristic is performed by a software component installed on the client computer.

20. The method of claim 17, wherein said adding at least one characteristic comprises modifying a header of said request.

21. The method of claim 20, wherein said modifying the header comprises modifying the user-agent header.

22. The method of claim 17, wherein said adding at least one characteristic comprises adding a new header to said request.

23. The method of claim 17, wherein identifying the at least one characteristic is performed by software means residing on the web server.

24. The method of claim 17, wherein selectively responding to the web-page request comprises:
checking the requested web page for compatibility with said at least one user characteristic;
sending the requested web-page to the user if the web-page is compatible with the at least one user characteristic;
masking out incompatible parts of the requested web-page if the web-page is partially compatible with the at least one user characteristic; and
notifying the user that the requested page is incompatible with the at least one user characteristic.

25. The method of claim 24, additionally comprising redirecting the user to an alternative web-page if the requested page is incompatible with the at least one user characteristic.

26. The method of claim 17, wherein identifying the at least one characteristic comprises sending an HTML document containing client-side code to the client computer.

27. The method of claim 26, wherein said client-side code is embedded in said HTML document.

28. The method of claim 26, wherein said client-side code comprises a separate document.

29. The method of claim 26, wherein said client-side code comprises a JavaScript.

30. The method of claim 26, wherein selectively responding to the web-page request comprises:
executing said client-side code;
exposing an ID object to said client-side code if said ID object is available and enabled; and
querying said ID object for said at least one user characteristic.

31. The method of claim 30, wherein selectively responding to the web-page request comprises:
checking the requested web page for compatibility with said at least one user characteristic;
sending the requested web-page to the user if the web-page is compatible with the at least one user characteristic;
masking out incompatible parts of the requested web-page if the web-page is partially compatible with the at least one user characteristic; and
notifying the user that the requested page is incompatible with the at least one user characteristic.

32. The method of claim 31, additionally comprising redirecting the user to an alternative web-page if the requested page is incompatible with the at least one user characteristic.
